(19) United States
(12) Patent Application Publication
(10) Pub. No.: US 2010/0083573 A1
(43) Pub. Date: Apr. 8, 2010

(54) SYSTEM FOR GROWING PLANTS

(76) Inventor: Steven William GALLO, Laval (CA)

Correspondence Address: DANIEL B. SCHEIN, PH.D., ESQ., INC., P. O. BOX 68128, Virginia Beach, VA, 23471, US

(21) Appl. No.: 12/246,578

(22) Filed: Oct. 7, 2008

(51) Int. Cl. A01G 31/00

(52) U.S. Cl. 47/59 R

(57) ABSTRACT

The present invention relates to a device for covering a plant growing medium. The device is comprised of two parts which may be assembled and placed upon a plant growing medium or assembled over a plant growing medium and existing plant. The device includes a sheet, and aperture defined by the sheet and a chamber. The chamber is suspended below a first portion of the sheet and above the plant growing medium. Liquid is delivered to the chamber through at least one hole defined by the cover and the liquid is dispersed from the chamber to the plant growing medium. The chamber includes a baffle for diverting the liquid to provide even distribution of the liquid to the plant growing medium.

### FIELD OF INVENTION

The present invention relates to a system for growing plants.

### BACKGROUND OF INVENTION

There are a number of situations in which it may be desirable to cultivate plants without having to use soil. For example, during the colder months of the year, some gardeners begin growing seedlings indoors in anticipation of spring. This process is more simple and sanitary when soil is not used. Alternatively, nutrient-rich soil may not be available.

Growing mediums other than soil may be used to germinate seeds. One popular growing medium is rockwool. Rockwool is used extensively for hydroponic growing systems. Rockwool is made by melting a combination of rock and sand and spinning the resulting mixture. This process produces fibres that may be formed into different shapes and sizes.

Rockwool absorbs and maintains water and other liquids. Further, rockwool is porous and thus retains oxygen. As a result, plants that grow in rockwool have healthy root systems. Finally, rockwool can be formed into a number of shapes and sizes. Frequently, rockwool fibres are compressed into cubes or blocks.

Rockwool cubes and blocks are manufactured in different sizes. Most commonly, the sides of the cubes are three inches, four inches or six inches long. If a plant has grown such that the rockwool cube has met its capacity, a larger cube can be hollowed out so that the smaller cube may be inserted into the larger cube, thus permitting further propagation of the plant's root system.

Before using a rockwool cube, the cube must be treated by soaking it in a nutrient solution to adjust its pH level. Further, once seeds or seedlings are placed in rockwool, the rockwool is periodically moistened. Therefore, rockwool is moist when in use.

The moisture of rockwool cubes creates some difficulties for the user. Specifically, when rockwool is exposed to the light that is normally used for indoor germination and cultivation of plants or sunlight in a greenhouse setting, algae forms on the surface of the moist rockwool cubes. Such algae attracts insects such as fungus gnats and shoreflies. Further, when algae decays and dies, it can become detrimental to plants since it may invite bacteria and viruses. Algae can even compete with the plants being grown for oxygen, which is necessary for nutrient uptake.

Covering rockwool also inhibits the evaporation of moisture that has been absorbed by the rockwool cube. Accordingly, covering a rockwool cube and protecting it from direct light ultimately conserves water.

To prevent the growth of algae on rockwool, it is necessary to deprive the algae of light. Algae flourishes in wet, well lit locations and depriving it of light prevents photosynthesis.

Various solutions have been proposed for covering rockwool cubes. However, previously disclosed rockwool cube covers suffer from a number of disadvantages. First, such covers limit the circulation of oxygen, thus creating an anaerobic environment. This inhibits nutrient uptake by the plant. Further, some previously disclosed cube covers are simply sheets of plastic that are placed above the cube and frequently engage the surface of the cube, thus further inhibiting the circulation of oxygen. Finally, previously disclosed covers for plant growing mediums cannot be placed over a plant growing from the plant growing medium without damaging the plant.

Rockwool cubes are frequently used as an irrigation component for a plant growing system. Such systems incorporate a means for delivering moisture (normally a nutrient solution) to the rockwool cubes. Most frequently, a series of hoses delivers the nutrient solution from a main reservoir to one or more drip stakes inserted into the rockwool cube. A hose engages the drip stake such that the nutrient solution from the hose trickles down the stake and is absorbed by the rockwool cube. Multiple drip stakes and hoses may be used for each rockwool cube to better disperse the nutrient solution. Each drip stake moors a hose in place to prevent the nutrient solution from leaking outside of the irrigation system.

There are a number of drawbacks to using the hose and drip stake system for delivering nutrient solutions to rockwool cubes or bricks. Such a system does not result in the efficient dispersal of nutrient solution to the rockwool and accordingly the root system does not receive an even distribution of moisture. Adding extra drip stakes and hoses adds costs and complicates the plant growing system. Specifically, extra hoses results in greater potential for entanglement and a greater likelihood that a hose will become disengaged from its corresponding drip stake such that nutrient solution drips away from the rockwool cube.

Further, especially when more than one plant is being grown such that multiple rockwool cubes are required, the process of placing each hose to engage a corresponding drip stake is time consuming. This problem is exacerbated when multiple drip stakes are utilized for each rockwool cube.

A smaller reservoir or chamber for liquid such as nutrient solution may be provided for each rockwool cube. However, placing the chamber upon or above the rockwool cube is difficult where a plant is already growing from the rockwool cube. As well, it would be desirable to ensure even distribution of the nutrient solution from the chamber to the rockwool cube.

### SUMMARY OF INVENTION

According to a first broad aspect of an embodiment of the present invention, there is disclosed a device for covering a plant growing medium comprising a sheet and an aperture defined by the sheet. The device also has at least one chamber for receiving liquid through at least one hole defined by the sheet, the at least one chamber integrally formed in the sheet such that the at least one chamber is suspended above the plant growing medium and below the sheet. The device also has at least one opening defined by the at least one chamber wherein the at least one opening is in communication with a plant growing medium. The device has at least two portions that may be placed laterally upon the plant growing medium so that the aperture is situated about a plant engaged with the plant growing medium.

According to a second broad aspect of an embodiment of the present invention, there is disclosed a device for use with a cover for a plant growing medium, the cover defining an aperture, the device comprising at least one chamber for receiving liquid through at least one hole defined by the cover. The device also has a baffle beneath the at least one hole for diverting received liquid into two portions of the at least one chamber. The device also has at least one opening defined by the at least one chamber wherein the at least one opening is in communication with the plant growing medium.

Descriptive references herein such as “planar”, “parallel”, “perpendicular”, “normal”, “straight”, “horizontal” or “vertical” are for convenience of description only. It will be appreciated by one skilled in the art that the placement of elements may depart moderately from a planar, parallel, perpendicular, normal, straight, horizontal or vertical configuration.

### BRIEF DESCRIPTION OF THE DRAWINGS

In drawings which illustrate by way of example only a preferred embodiment of the invention:

FIG. 1 is a perspective view of a top surface of an embodiment of the device in an assembled position;

FIG. 2 is a perspective view of a bottom surface of the device of FIG. 1;

FIG. 3 is a top perspective view of a front side of the device of FIG. 1 a disassembled position;

FIG. 4 is a sectional view of a portion of the device along line 4-4 of FIG. 3;

FIG. 5 is a top perspective view of the device of FIG. 1 in an assembled position and set upon a plant growing medium; and

FIG. 6 is a bottom perspective view of a cut-out portion of the device of FIG. 1.

### DETAILED DESCRIPTION OF THE PREFERRED EMBODIMENTS

The present invention will now be described for the purposes of illustration only in connection with certain embodiments. However, it is to be understood that other objects and advantages of the present invention will be made apparent by the following description of the drawings according to the present invention. While preferred embodiments are disclosed, this is not intended to be limiting. Rather, the general principles set forth herein are considered to be merely illustrative of the scope of the present invention and it is to be further understood that numerous changes may be made without straying from the scope of the present invention.

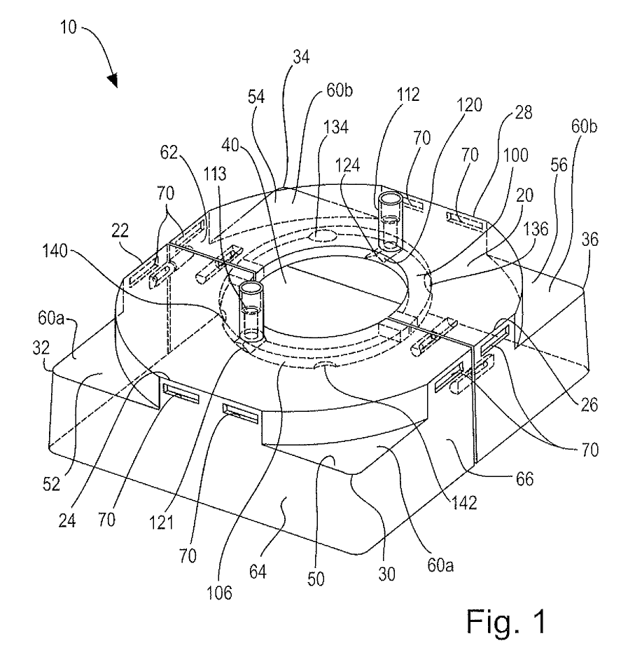

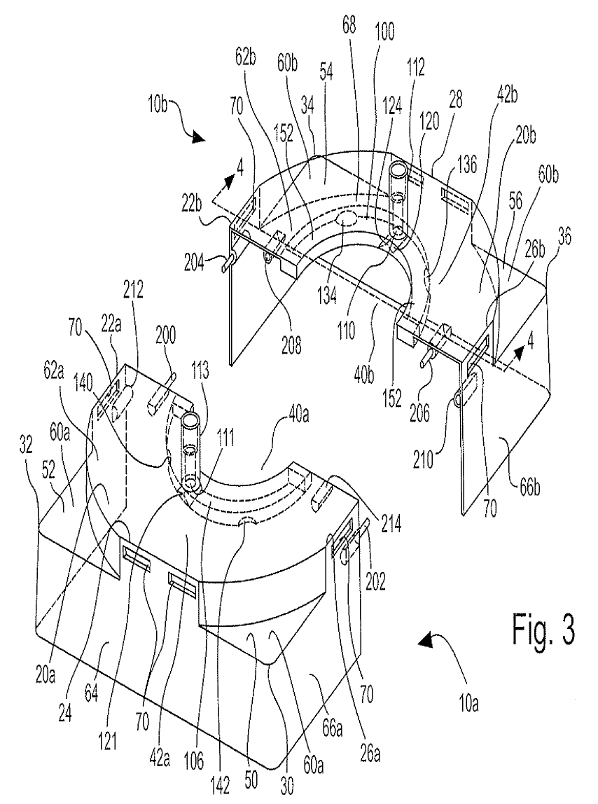

A cover 10 for a plant growing medium is shown in FIGS. 1, 2 and 5. The cover 10 comprises two cover portions 10a and 10b, as shown in FIG. 3, which may be coupled together as described below to create the cover 10. It will be apparent to a person skilled in the art that the objects of the invention may be satisfied by dividing the cover into any number of portions greater than one and such embodiments are contemplated. The cover portions 10a and 10b are constructed from a suitably rigid material such as plastic.

The cover 10 has a sheet 20 which is comprised of two sheets 20a and 20b on the cover portions 10a and 10b respectively. The sheets 20a and 20b create the sheet 20 when the cover portions 10a and 10b are assembled. The sheets 20a and 20b may be of any shape or size such that, when the cover 10 is assembled, sheet 20 covers a surface of a plant growing medium that is directly exposed to light. In the embodiment shown in the Figures, the resulting sheet 20 is square. Preferably, the sheet 20 is substantially planar. As shown in FIG. 3, sheet 20a has three edges 22a, 24 and 26a and sheet 20b has three edges 22b, 28 and 26b. Edges 22a and 22b and edges 26a and 26b create edges 22 and 26 respectively when the cover portions 10a and 10b are assembled. The four edges 22, 24, 26 and 28 of the sheet 20 meet at four corners 30, 32, 34 and 36 on the assembled device 10.

Each sheet 20a and 20b defines a portion of an aperture 40a and 40b. When assembled, the portions of the apertures 40a and 40b create an aperture 40. First portions 42a and 42b of the sheets 20a and 20b surround the portions of the apertures 40a and 40b respectively.

The aperture 40 may have any shape or size. In the embodiment shown in the Figures, the portions of the apertures 40a and 40b are semi-circular, resulting in an aperture 40 which is circular. The aperture 40 shown in FIG. 1 is orientated at the centre of the sheet 20. Also as shown in FIG. 3, the cover 10 is comprised of symmetrical halves 10a and 10b. It will be apparent to a person skilled in the art that it is not necessary for the aperture 40 to be orientated at the centre of the sheet 20 or for the cover portions 10a and 10b and the portions of the apertures 40a and 40b to be of equal size. By altering the sizes of the cover portions 10a and 10b and the size and location of the portions of the apertures 40a and 40b, it will be apparent to a person skilled in the art that the aperture 40 also may be in a different position in the sheet 20 such as near one of the edges 22, 24, 26 or 28 of the sheet 20. The cover portions 10a and 10b and the portions of the apertures 40a and 40b also may be asymmetric.

Each sheet 20a and 20b has a second section incorporating at least one ledge. As shown in FIG. 3, there are two ledges 50 and 52 on sheet 20a and two ledges 54 and 56 on sheet 20b. It will be apparent to a person skilled in the art that the objects of the invention may be satisfied by incorporating any number of ledges and embodiments incorporating one or more ledges are contemplated.

As seen in FIG. 3, each of the ledges 50 and 52 is orientated at a second portion 60a of the sheet 20a proximate to one of the corners 30 or 32 of the sheet 20a. Further, each of the ledges 50 and 52 is integrated with the first portion 42a of the sheet 20a surrounding the portion of the aperture 40a. Each of the ledges 50 and 52 is orientated at a height below the height of the first portion 42a of the sheet 20a surrounding the portion of the aperture 40a. In a preferred embodiment, each of the ledges 50 and 52 is in a plane parallel to the plane of the sheet 20a.

Similarly, each of the ledges 54 and 56 is orientated at a second portion 60b of the sheet 20b proximate to one of the corners 34 or 36 of the sheet 20b. Further, each of the ledges 54 and 56 is integrated with the first portion 42b of the sheet 20b surrounding the portion of the aperture 40b. Each of the ledges 54 and 56 is orientated at a height below the height of the first portion 42b of the sheet 20b surrounding the portion of the aperture 40b. In a preferred embodiment, each of the ledges 54 and 56 is in a plane parallel to the plane of the sheet 20b.

In a preferred embodiment of the cover, three walls 62a, 64 and 66a are attachable to the sheet 20a and three walls 62b, 68 and 66b are attachable to the sheet 20b. Walls 62a and 62b and walls 66a and 66b create walls 62 and 66 respectively when the cover portions 10a and 10b are assembled. In the embodiment shown in FIG. 1, with the cover 10 assembled, each of the walls 62, 64, 66 and 68 is slightly slanted and flares outward from the top of the wall to the bottom of the wall. In a preferred embodiment, each of the walls 62, 64, 66 and 68 opposes one of the other walls.

Each of the walls 62a, 62b, 64, 66a, 66b and 68 define one or more slits 70. Each of the slits 70 is orientated above the height of the ledges 50, 52, 54 and 56. In the embodiment shown in the Figures, each of the slits 70 is rectangular, though the objects of the invention may be achieved by providing the slits with an alternative shape. As well, more than one slit may be defined in each of the walls as shown in FIG. 1 and walls 64 and 68.

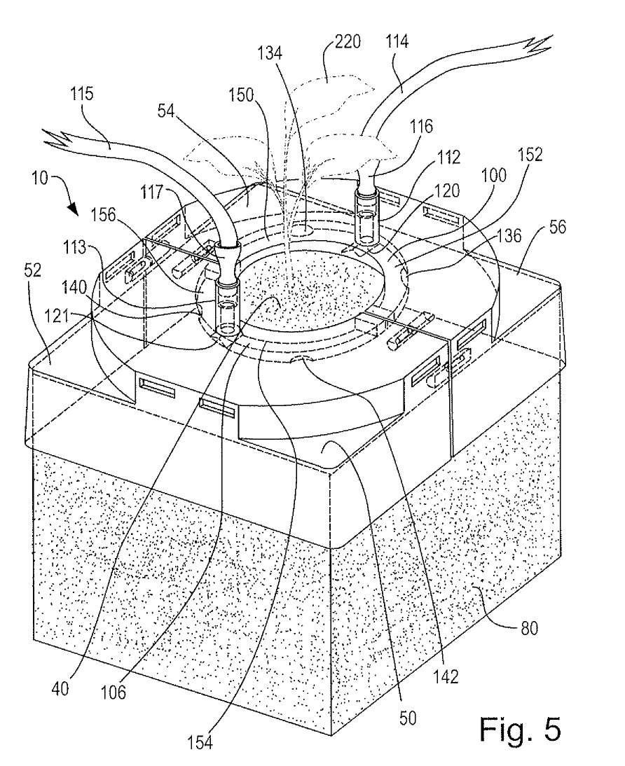

As seen in FIG. 5, in operation, the cover 10 is assembled over or placed upon a plant growing medium 80. The plant growing medium 80 can be any suitable medium for growing plants, including soil, coco blocks and rockwool blocks. The shape and dimensions of the cover 10 must be such that the cover 10 fits on the plant growing medium 80 and each of the ledges 50, 52, 54 and 56 engages a top surface of the plant growing medium 80. Specifically, the distance between the sets of opposing walls distal from the sheet 20 must be greater than the distance between opposing walls of the plant growing medium. In the embodiment shown in FIG. 5, the plant growing medium is malleable such that a portion of each of the walls 62, 64, 66 and 68 of the cover 10 proximate to the sheet 20 engages the plant growing medium 80. The resulting friction between the cover 10 and the plant growing medium 80 holds the cover 10 upon the plant growing medium 80 in systems where the plant growing medium 80 is rotated.

When the cover 10 is situated on the plant growing medium 80, each of the ledges 62, 64, 66 and 68 engages a top surface of the plant growing medium 80 and thus prevents a user from pressing the cover 10 onto the plant growing medium 80 to a level where the slits are not above the top surface of the plant growing medium 80.

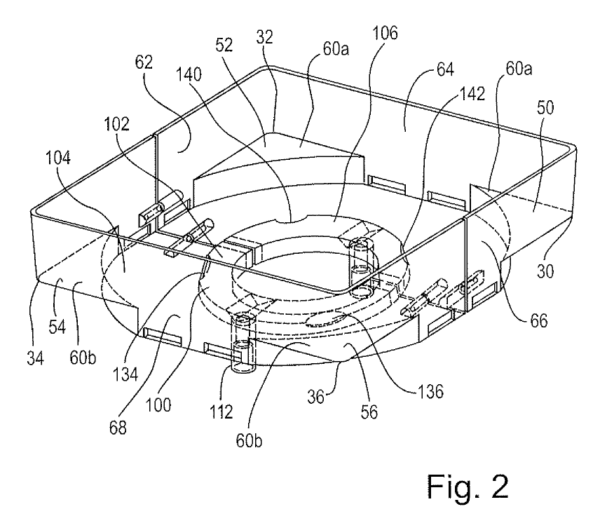

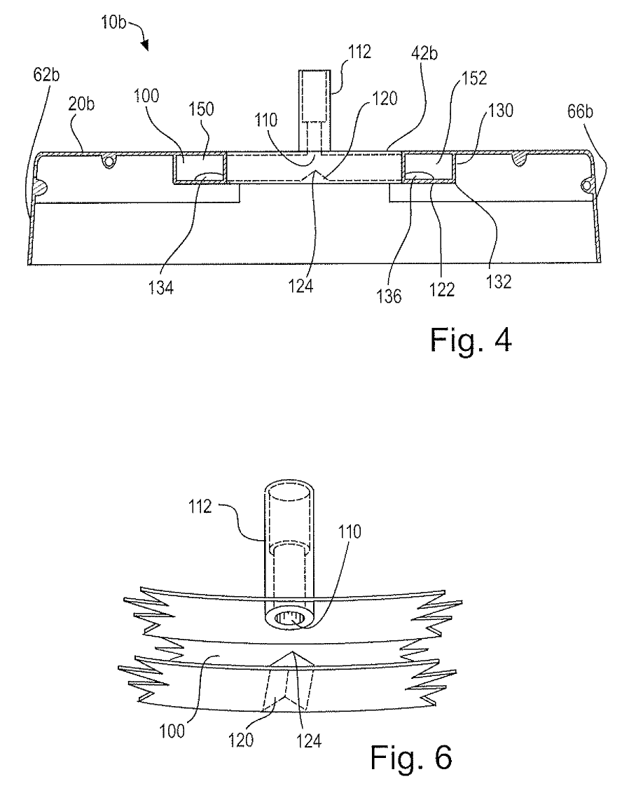

As seen in the Figures and with reference to FIGS. 2 to 4, a chamber 100 is defined in the cover portion 10b. The chamber 100 provides a means of receiving and delivering a liquid, such as a nutrient solution, to the plant growing medium 80 as described below. As shown in FIG. 3, in a preferred embodiment, the chamber 100 is situated below the first portion of the sheet 42b surrounding the portion of the aperture 40b and above the second portion of the sheet 60b such that the outer bottom surface 102 of the chamber 100 does not engage the plant growing medium 80 when the cover 10 is situated over the plant growing medium 80.

The chamber 100 is shown as a semi-circular channel surrounding the portion of the aperture 40b and contained within the cover portion 10b. It will be apparent to a person skilled in the art that the chamber 100 may be any suitable shape and size and may be situated at other locations below the first portion of the sheet 42b and above the second portion of the sheet 60b. The chamber 100 may be formed integrally within the cover portion 10b or may be formed separately from a suitably rigid material such as plastic and affixed to the bottom surface 104 of the first portion of the sheet 42b. Alternatively, the chamber 100 may be suspended above the plant growing medium 80 and below the cover portion 10b by a number of means, including engagement with the plant growing medium 80 or the cover portion 10b or both.

As shown in FIG. 6, a hole 110 is defined in the cover portion 10b, the hole 110 being in communication with the chamber 100. A cylindrical guide 112 extends upwards from the hole 110 and cover portion 10b. As shown in FIG. 5, the guide 112 and hole 110 provide a means for delivering liquid to the chamber 100. The guide 112 may engage a hose 114 and hose attachment 116 or other parts of the irrigation system (not shown).

A baffle 120 extends upwardly from the bottom wall 122 of the chamber 110. The baffle 120 is located adjacently below the hole 110. In a preferred embodiment, the baffle 120 is generally triangular-shaped with an apex 124 centered below the hole 110. The baffle 120 divides the chamber 100 into two areas 150 and 152.

One or more openings are defined by the chamber 100. The openings may be located in the bottom wall 122, in the outer side wall 130, or in the edge 132 of the chamber 100. As shown in FIG. 3, there are two openings 134 and 136 in the edge 132 of the chamber 100 of the cover portion 10b. The openings 134 and 136 are equal in size and shape and are equally spaced in the chamber 100. An opening is located in the chamber 100 on each side of the baffle 120 with one opening 134 in the area 150 and one opening 136 in the area 152.

Similarly, a chamber 106 is shown in the cover portion 10a. A hole 111 is defined in the cover portion 10a, the hole 111 being in communication with the chamber 106. A cylindrical guide 113 extends upwards from the hole 111 and cover portion 10a. The guide 113 engages parts of the irrigation systems such as a hose 115 and hose attachment 117 for delivering the nutrient solution to the chamber 106. The chamber 106 includes a baffle 121 which divides the chamber 106 into areas 154 and 156. An opening 142 is provided in the area 154 and an opening 140 is provided in the area 156.

As shown in FIGS. 1 to 3, the cover portions 10a and 10b may be assembled and held together using a number of pins 200, 202, 204 and 206 and corresponding sockets 208, 210, 212 and 214. The pins 200, 202, 204 and 206 are generally cylindrical-shaped and may be formed of the same rigid material as the cover portions 10a and 10b. Sockets 208, 210, 212 and 214 also may be formed from the same rigid material as the cover portions 10a and 10b. The sockets 208, 210, 212 and 214 define cylindrically-shaped openings for receiving and frictionally engaging the corresponding pins 200, 202, 204 and 206.

The pins 200, 202, 204 and 206 may be located below the sheet portions 20a and 20b or inside the walls 62a, 62b, 66a and 66b of the cover portions 10a and 10b. Socket 212 and pin 202 are orientated above the height of the ledges 52 and 50, respectively. Pin 204 and socket 210 are orientated above the height of the ledges 54 and 56, respectively. The pins 200, 202, 204 and 206 and sockets 208, 210, 212 and 214 are orientated so as not to engage or interfere with the plant growing medium 80. On the walls 62a, 62b, 66a and 66b, pins 202 and 204 and sockets 210 and 212 may be located below the slits 70 as shown. It will be apparent to a person skilled in the art that the positions of the slits 70 and the pins 202 and 204 and sockets 210 and 212 also may be reversed.

As shown in FIG. 3, the pins 200, 202, 204 and 206 and corresponding sockets 208, 210, 212 and 214 may be alternated between the cover portions 10a and 10b, with pins 200 and 202 on the cover portion 10a connecting with sockets 208 and 210 on the cover portion 10b. Similarly, pins 204 and 206 on the cover portion 10b connect with the sockets 212 and 214 on the cover portion 10a.

It will be apparent to a person skilled in the art that the objects of the invention may be achieved by incorporating any number of sockets and pins or other hinges, latches or connection means to assemble the cover portion 10a and the cover portion 10b. Connection means may be provided below the level of the ledges 50, 52, 54 and 56, and outside or in the walls 62a, 62b, 66a and 66b, so as not to interfere with the engagement of the walls 62, 64, 66 and 68 of the cover 10 and plant growing medium 80 as described previously.

To assemble the cover 10, the cover portions 10a and 10b are moved laterally together. Pins 200, 202, 204 and 206 are aligned and connected with the sockets 208, 210, 212 and 214. Cover portions 10a and 10b are pushed together and pins 200, 202, 204 and 206 frictionally engage sockets 208, 210, 212 and 214. The cover portions 10a and 10b may be assembled and placed over the plant growing medium 80. Alternatively, where a plant 220 is growing from the plant growing medium 80 the cover portion 10a and the cover portion 10b may be applied laterally from opposite directions and assembled about the plant 220 so that the aperture 40 surrounds the stem of the plant 220. Accordingly, during the process of assembling and applying the cover 10 to the plant growing medium 80, the cover 10 does not engage the plant 220.

An irrigation system (not shown) may be attached to the cover 10 to provide liquid to the plant growing medium 80 via the chambers 100 and 106. As shown in FIG. 5, hoses 114 and 115 may be attached to the cover 10 through the cylindrical guides 112 and 113 and with hose attachments 116 and 117. It will be apparent to a person skilled in the art that a number of means may be used to secure the irrigation system to the cover 10 and to the guides 112 and 113. In operation, liquid is provided through the hose 114. The liquid travels through the guide 112 and hole 110 in the cover 10 to the chamber 100. As liquid enters the chamber 100 it is diverted over the baffle 120 and into the areas of the chamber 150 and 152 on either side of the baffle 120. The liquid proceeds through the openings 134 and 136 and is distributed to the plant growing medium 80. Similarly, liquid is provided through the hose 115. The liquid travels through the guide 113 and hole 111 in the cover 10 to the chamber 106. As liquid enters the chamber 106 it is diverted over the baffle 121 and into the areas of the chamber 154 and 156 on either side of the baffle 121. The liquid proceeds through the openings 140 and 142 and is distributed to the plant growing medium 80.

In the embodiment shown in FIG. 5, liquid may be provided from the hoses 114 and 115 and distributed via the two chambers 100 and 106 to four openings 134, 136, 140 and 142. Even distribution of the liquid is provided to the plant growing medium 80. It will be apparent to a person skilled in the art that the position and number of openings may be varied to increase or alter the distribution of the liquid to the plant growing medium 80. It will be apparent to a person skilled in the art that the number of chambers, holes, guides and baffles also may be varied.

It will be apparent to those having ordinary skill in this art that various modifications and variations may be made to the embodiments disclosed herein, consistent with the present invention, without departing from the spirit and scope of the present invention. Other embodiments consistent with the present invention will become apparent from consideration of the specification and the practice of the invention disclosed herein. Accordingly, the specification and the embodiment are to be considered exemplary only, with a true scope and spirit of the invention being disclosed by the following claims.

1. A device for covering a plant growing medium comprising:
a sheet;
an aperture defined by the sheet;
at least one chamber for receiving liquid through at least one hole defined by the sheet, the at least one chamber integrally formed in the sheet such that the at least one chamber is suspended above the plant growing medium;
at least one opening defined by the at least one chamber wherein the at least one opening is in communication with the plant growing medium; and
the device having at least two portions that may be placed laterally upon the plant growing medium so that the aperture is situated about a plant engaged with the plant growing medium.

2. The device of claim 1 further comprising at least one ledge for engaging a top surface of the plant growing medium and attached to the sheet such that the at least one ledge is situated at a height below the height of the sheet.

3. The device of claim 1 wherein each portion of the device further consists of three walls and wherein each wall is attachable to the sheet and engages the plant growing medium.

4. The device of claim 1 having two portions.

5. The device of claim 1 wherein at least two portions are fixedly attachable to one another.

6. The device of claim 5 further comprising a plurality of pins and sockets on one portion of the device frictionally engaging a plurality of sockets and pins on a second portion of the device.

7. The device of claim 1 further comprising at least one baffle in the at least one chamber adjacent the at least one hole, wherein the baffle diverts received liquid into at least two portions of the chamber.

8. The device of claim 1 further comprising at least two chambers for receiving liquid through at least two holes.

9. The device of claim 8 further comprising at least one baffle in each of the at least two chambers, beneath the at least one hole wherein each baffle diverts received liquid into at least two portions of each chamber.

10. The device of claim 9 wherein each of the at least two portions of the chamber defines an opening in communication with the plant growing medium.

11. The device of claim 8 wherein at least one chamber is defined in each of the two portions of the device.

12. The device of claim 8 wherein the chambers comprise semicircular channels adjacent the aperture.

13. A device for use with a cover for a plant growing medium, the cover defining an aperture, the device comprising:
at least one chamber for receiving liquid through at least one hole defined by the cover;
a baffle beneath the at least one hole for diverting received liquid into two portions of the at least one chamber; and
at least one opening defined by the at least one chamber wherein the at least one opening is in communication with the plant growing medium.

14. The device of claim 1, wherein said at least one chamber is below said sheet.
